(19) United States
(12) Patent Application Publication
(10) Pub. No.: US 2004/0000067 A1
(43) Pub. Date: Jan. 1, 2004

(54) Personal drying apparatus

(76) Inventor: Hans D. Baumann, Rye, NH (US)

Correspondence Address: Hans D. Baumann Ph.D., 32 Pine Street, Rye, NH, 03870, US

(21) Appl. No.: 10/183,617

(22) Filed: Jun. 28, 2002

(51) Int. Cl. F26B 19/00

(52) U.S. Cl. 34/90; 392/380

(57) ABSTRACT

An apparatus for generating a uniform and heated series of air jets capable of drying a substantial portion of a human body surface in a uniform and efficient manner and using electrically activated and heated air blowers.

### FIELD OF THE INVENTION

The present invention relates to personal grooming devices, especially to devices capable to provide a more hygienic substitute for drying towels when drying the substantial portion of a human body.

### BACKGROUND OF THE INVENTION

While electrically operated hair dryers or hand dryers have been known for some time, there is believed to be a need to develop a drying device capable of drying, with the use of hot air, the substantial human body surface area. This would be especially advantageous in hotels and similar locations, where the use of bath towels could be dispensed with. Such mode of drying not only would be more hygienic but also would lead to substantial cost savings by eliminating the expenditures for laundry services and replacements of towels. Additional advantages in comfort will derive from eliminating the coolness produced from having a low dew point in the surrounding air.

The present invention describes such a device that, once activated, will surround a substantial portion of the human skin area with a drying stream of warm air. Rotating the body in front of the device will allow air to cover previously un-dried skin surfaces. The device consists of a vertical housing having typically one concave surface running the height of the housing. The housing incorporates one or more electric bowers installed near the bottom of said housing. Said blowers furthermore have an internal heating element similar to hair dryers. The blower sucks air through an opening near the bottom of said housing and, after heating the air, blows the warm air through a series of slots or perforations arranged in such a manner, that the air flow exiting the slots has near uniform velocity thereby insuring near uniform coverage of the human body skin. Additional temperature controls may also be provided.

A position sensitive switch is installed near the blower to interrupt the flow of electrical current in case the apparatus is accidentally toppled.

### BRIEF DESCRIPTION OF THE DRAWINGS

FIG. 1 is a diagrammatic illustration of the current invention:

FIG. 2 Is a close-up view of the electrical portion of the invention removed from the housing in FIG. 1.

### DESCRIPTION OF THE ILLUSTRATED EMBODIMENT

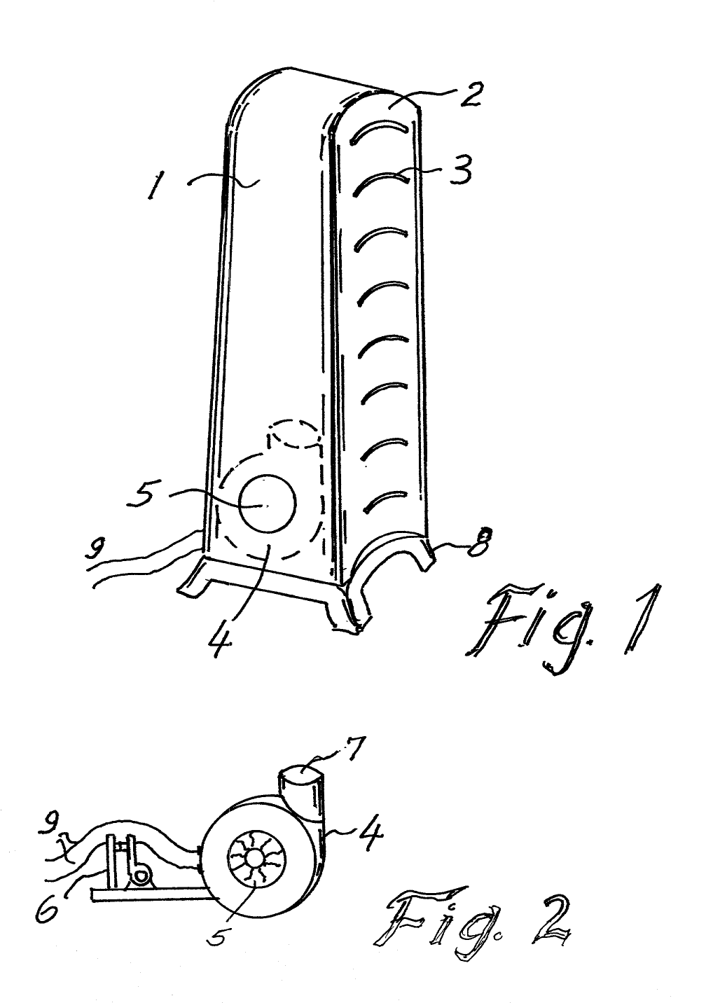

Referring to FIG. 1, my invention comprises a hollow, vertical housing 1 having an elongated shape, wherein one of the side panels 2 has a concave shape throughout its length. A number of elongated slots 3 penetrate said side panel 2. The length of these slots vary from the bottom to the top in order to allow for even air distribution. Such air flow is generated by an electric blower 4 which is installed near the bottom of housing 1 and which features an electric heating element (not shown). Air is sucked in by blower 4 through an opening 5 from the exterior of housing 1. Electrical conduit wires 9 emanate from the blower 5 and pass through a position sensitive switch 6 of conventional design and capable of disruption the flow of electrical current when the housing is in other than the upright position. The wires then connect to a typical switched wall outlet.

The warm air coming from blower 5 is exiting through opening 7 into the interior of the hollow housing 1 before escaping through slots 3. The surface area of all slots is configured to create an exit velocity that would yield an air jet of at least 12 inches in length or at least the normal standing distance of a person from the housing 1. The spacing between adjacent slots 3 is selected in such a manner as to provide a merging of the air jets at a desired distance from the housing that is in close proximity to where a person would be standing.

Housing 1 is typically constructed from molded plastic, colored to match the interior of bathrooms, and housing 1 furthermore may be supported by heavier metal legs 8 in order to give it stability and sturdiness.

The standing height of the housing is typically five feet in order to cover the substantial height of a human torso.

Numerous modifications and alternative embodiments of the present invention will be apparent to those skilled in the art in view of the forgoing description. Details of the structure may vary substantially such as varying the height of the apparatus, wall mounting the housing, adding temperature controls, and adding on-off switches without departing from the spirit of the present invention.

What is claimed is:

1. A personal drying apparatus comprising a hollow elongated, vertically arranged housing, having a top and a bottom, and having at least one perforated wall surface, an electrically operated blower attached to said housing and capable of moving air through the perforations of said housing.

2. A personal drying apparatus according to claim 1, wherein said housing has at least one concave external wall surface.

3. A personal drying apparatus according to claim 2, wherein said perforations extend through most of said concave wall surface.

4. A personal drying apparatus according to claim 1, wherein said perforations constitute a series of slots.

5. A personal drying apparatus according to claim 4, wherein the length of each slot increases from the bottom to the top of said housing.

6. A personal drying apparatus according to claim 1, wherein said blower is installed near the bottom of said housing and having a pair of electrical conduit wires connecting to an electrical outlet (not part of this invention).

7. A personal drying apparatus according to claim 6, wherein a position sensitive switch is installed within said housing and being part of said electrical conduit and furthermore being capable to interrupt electrical current flowing through said conduit wires to the blower in case the housing position is accidentally changed from the normal vertical.

8. A personal drying apparatus according to claim 1, wherein said housing has supportive legs located at the bottom.

9. A personal drying apparatus according to claim 1, wherein the cross-sectional area of each perforation is configured to establish a desired velocity of the air flowing through it.

10. A personal drying apparatus according to claim 1, wherein said blower incorporates a heating element in order to pre-heat the air passing it.

11. A personal drying apparatus according to claim 1, wherein the spacing between adjacent perforations is selected in order to force a merging of individual jets emanating from said perforations at a pre-determined distance from said housing.
